(19) United States
(12) Patent Application Publication
(10) Pub. No.: US 2011/0313906 A1
(43) Pub. Date: Dec. 22, 2011

(54) COMPUTER-INTEGRATED SECURITIES FINANCING SYSTEM AND METHOD

(75) Inventors: Chaolun Harry JIN, West Windsor, NJ (US); Hozaifa ARSIWALA, New York, NY (US)

(73) Assignee: THE BANK OF NEW YORK MELLON, New York, NY (US)

(21) Appl. No.: 12/819,655

(22) Filed: Jun. 21, 2010

(51) Int. Cl. G06Q 40/00

(52) U.S. Cl. 705/37

(57) ABSTRACT

In one embodiment, a securities financing system integrates processing of both securities lending and repurchase (repo) agreement transactions conducted over a network. A securities financing platform has multiple modules and a management interface module through which input and output functions are provided to a system manager. Network communications are configured to manage respective data interfaces over the network with a first party borrower to the collateralized financial transaction, a second party lender to the collateralized financial transaction, and a central counterparty configured to provide trade netting and novation services to each of the first and second parties. A central counterparty interface is configured such that the central counterparty becomes a counterparty to each of the first party borrower and the second party lender through the securities financing system.

### BACKGROUND

This application is directed to a computer-integrated securities financing platform (i.e., computer-implemented system), and method useful for processing the reinvestment or “mobilization” of assets provided as collateral in connection with the lending of securities. This application is particularly directed to a computer-implemented system and method that provides reduced bilateral credit risk by use of a central counterparty that “steps in” to become a counterparty to each party to the transaction.

Conventionally, a prime brokerage is a bundled package of services offered by investment banks and securities firms to hedge funds and other professional investors needing the ability to borrow securities (generically “financial instruments”) and cash to be able to invest on a leveraged basis, and to achieve an absolute return. A prime broker provides a centralized securities clearing facility for the hedge fund, and the hedge fund's collateral requirements are netted across all deals handled by the prime broker.

The prime broker consolidates client accounts into one master account while providing clearing, settlement and custody services, securities lending, leverage and consolidated reporting. A prime broker fulfills the functions of both the traditional custodian account and the traditional brokerage account.

Before the recent financial instability in the United States, a prime broker or broker dealer had strong balance sheets and no balance sheet constraint, and the credit exposure of the hedge fund to the prime broker was thought to be minimal. The hedge fund typically surrendered their balance sheet to prime broker who had re-hypothecation rights to use the client's assets freely, and prime brokers were self-sufficient in financing their own prime brokerage operations such that they could, in the past, afford to provide financing at competitive rates to hedge funds.

However, after financial markets were destabilized in 2008-2009, many broker dealers were converted to traditional commercial banks such that prime brokers now face some balance sheet constraints similar to any other commercial bank. Hedge funds are removing unencumbered assets and cash away from prime brokers in search of a secure haven for their assets, such as custodian banks Hedge fund managers are particularly concerned that re-hypothecation rights allow prime brokers to use client assets even when the hedge fund is not running leverage, and they are now much more concerned about the creditworthiness of the investment banks that are their counterparts. Further, prime brokers generally no longer able to self-finance operations.

In addition, conventional inter-prime broker lending was taken for granted, and assumed to take place at benchmark rates. That mechanism seized up in September 2008 as Lehman Brothers went into bankruptcy, and banks and dealers stopped lending to each other in overnight markets. As a consequence, prime brokers have raised the fees they charge for borrowed securities, while the lenders themselves are seeking higher-quality collateral, such as cash. Furthermore, prime brokers are anxious to avoid funds that run up heavy losses in current volatile and illiquid markets, and have tightened their criteria for lending to hedge funds. All of the above indicate that hedge funds will need to seek alternative sources of portfolio financing going forward.

A Sale and Repurchase Agreement, better known as Repurchase Agreements (RPs or “Repos”), has a borrower (seller/cash receiver) sell securities for cash to a lender (buyer/cash provider) and agree to repurchase those securities at a later date for more cash. The Repo rate is the difference between borrowed and paid back cash expressed as a percentage. Repurchase agreements are financial instruments used in money markets and capital markets. A Repo is economically similar to a secured loan, with the buyer receiving securities as collateral to protect against default. There is little that prevents any security from being employed in a Repo such that Treasury or Government bills, corporate and Treasury/Government bonds, and stocks/shares may all be used as securities or financial instruments involved in a Repo agreement. However, the legal title to the securities clearly passes from the seller to the buyer, or “investor”. Coupons (installment payments that are payable to the owner of the securities) which are paid while the Repo buyer owns the securities are, in fact, usually passed directly onto the repo seller which might seem counterintuitive, as the ownership of the collateral technically rests with the buyer during the Repo agreement. It is possible to instead pass on the coupon by altering the cash paid at the end of the agreement, though this is more typical of Sell/Buy Backs.

Although the underlying nature of the Repo transaction is that of a loan, the terminology differs from that used when talking of loans because the seller does actually repurchase the legal ownership of the securities from the buyer at the end of the agreement. Although the actual effect of the whole transaction is identical to a cash loan, in using the “repurchase” terminology, the emphasis is placed upon the current legal ownership of the collateral securities by the respective parties.

Temporary market dislocations such as described above come and go over time. However, during the duration of such market dislocations, asset-rich but cash-poor borrowers without the ability to execute a Repo agreement or who have illiquid assets that it prefers not to sell, e.g., leases, licenses, patents, plant, equipment, networks, etc., are unable to obtain greatly needed short-term financing for day-to-day operations due to the few options available.

What is needed is a computer-implemented platform and method that matches excess cash to securities and/or excess securities to cash between borrowers and investors. What is further needed is a computer-implemented platform and method which provides seamless integration of securities financing for both securities lending and repurchase agreement financing. In addition, what is needed is a computer-implemented platform and method that improves liquidity of securities and reduces bilateral credit risk by interfacing with a central counterparty that steps in, over the network to provide contract novation and netting of collateral requirements across all transactions conducted on the platform.

### SUMMARY

Hedge funds have been placing increasing amount of their securities and cash withdrawn from prime brokers with custodian banks. For example, various embodiments of the securities financing platform and method of this disclosure enables hedge funds to mobilize their security assets and cash to borrow and lend directly with each other. In addition, the platform can introduce liquidity by utilizing other institutional investors' securities and cash that is maintained under the custody of or “custodized” by the platform manager, e.g., The Bank of New York Mellon. The computer-implemented system and method of this disclosure allow hedge funds to bypass prime brokers and borrow directly from institutional investors, thus reducing credit risk and improving liquidity of various securities.

Among other things, this disclosure provides embodiments of a computer-implemented method of processing a collateralized financial transaction over a network that includes the steps of: providing a securities financing system including a memory device and one or more processors configured to process information transmitted over the network related to a financial instrument that is connected with the collateralized financial transaction, said securities financing system including respective network data interfaces with at least each of a first party borrower to the collateralized financial transaction, a second party lender to the collateralized financial transaction, and a central counterparty configured to provide trade netting and novation services to each of the first and second parties, said securities financing system having an interface with a system manager responsible for monitoring and controlling the collateralized financial transaction; matching the financial instrument through the securities financing system to a security held within a pool of assets under custody by the system manager for one or more clients of the securities financing system, said one or more clients having executed a give-up agreement with the system manager; negotiating details of the collateralized financial transaction between the first party and the second party through the securities financing system; responsive to a successful negotiation, executing a trade agreement between the first party borrower and the second party lender for the financial instrument via the network and electronically transferring control of the financial instrument between respective lender and borrower custody accounts maintained in a database in the memory device; and novating the trade agreement by the central counterparty, wherein the central counterparty becomes a counterparty to each of the first party borrower and the second party lender through the securities financing system.

In other aspects, the method may include securing, by the system manager, collateral from the first party borrower for the executed trade agreement via a collateral module in the securities financing system, wherein said collateral may be in one or more of cash or securities including stocks, bonds, Letter of Credit, and/or commercial paper, or a combination of cash and securities.

A safeguard valuation and eligibility determination may independently be made by one or more system modules, e.g., a collateral module, for any non-cash collateral that is allocated to the executed trade agreement.

In one or more embodiments, a securities financing system may be configured to integrate processing of both securities lending and Repurchase Agreement financing in a single computer-implemented platform or, alternatively, the securities financing system may be configured to process securities lending to facilitate covering a short position in a security or may be configured to process Repurchase Agreement financing to facilitate the borrowing or lending of cash.

In a further aspect of one or more embodiments, negotiating details of the collateralized financial transaction may be conducted anonymously between the first party and the second party through the securities financing system. For example, a central counterparty interface may be configured to provide anonymity between the securities borrower and the securities lender.

In another embodiment, a computer-implemented securities financing system for processing a collateralized securities lending transaction over a network includes a securities financing platform comprising a network interface configured to provide respective data interfaces over the network with at least each of a securities borrower, a securities lender, and a central counterparty associated with the collateralized securities lending transaction. The central counterparty provides trade netting and novation services for the collateralized securities lending transaction to each of the securities borrower and the securities lender via a central counterparty interface configured to novate a trade agreement by the central counterparty such that the central counterparty becomes a counterparty to each of the securities borrower and the securities lender through the securities financing platform. This and related functionality may be implemented by one or more processors operatively connected to one or more of a plurality of modules, and the processor(s) may be configured to process information related to the collateralized securities lending transaction and to selectively provide the information over the network interface. A memory storage device is operatively coupled to the one or more processors and configured to store information related to a financial instrument that is a subject of the collateralized financial transaction in one or more databases, e.g., a structured database.

In this and related embodiments, the plurality of modules may include a securities lending services module configured to locate and match the financial instrument to a security held within a pool of assets under custody by a system manager for one or more clients of the securities financing system, said one or more clients having executed a give-up agreement with the system manager; an asset custody management module; and a cash and collateral management module. In various embodiments, a platform management module is included through which input and output functions are provided to the system manager, which may be configured to support and review negotiation of details of the collateralized financial transaction between the securities borrower and the securities lender and, responsive to a successful negotiation, to execute the trade agreement between the securities borrower and the securities lender by electronically transferring custody of the financial instrument between respective lender and borrower custody accounts maintained in said one or more databases in the memory device.

In one or more embodiments, the cash and collateral management module maintains both an encumbered account and an unencumbered account in said one or more databases for the benefit of the securities borrower.

In one or more embodiments, the securities lending services module may be further configured to initiate a request for a particular security to a third party in response to a determination that the financial instrument is not held within the pool of assets under custody by the system manager.

In another aspect of an embodiment, a cash and collateral management module may be configured such that any collateral associated with the collateralized securities lending transaction is maintained under custody and control of the system manager.

In another embodiment, a computer-implemented securities financing system for processing a repurchase (repo) agreement over a network includes a securities financing platform comprising: a network interface configured to provide respective data interfaces over the network with at least each of a collateral provider, an investor, and a central counterparty associated with the repo agreement, said central counterparty providing trade netting and novation services for the repo agreement to each of the collateral provider and the investor via a central counterparty interface configured to novate a trade agreement by the central counterparty such that the central counterparty becomes a counterparty to each of the collateral provider and the investor through the securities financing platform; one or more processors operatively connected to one or more of a plurality of modules, said one or more processors being configured to process information related to the repo agreement, said information being selectively provided to the network over the network interface; a memory storage device operatively coupled to the one or more processors, said memory device being configured so as to store information related to a financial instrument that is a subject of the repo agreement in one or more databases contained therein. The plurality of modules may include a broker/dealer services module configured to locate and match the financial instrument to a security held within a pool of assets under custody by a system manager for one or more clients of the securities financing system, said one or more clients having executed a give-up agreement with the system manager; a custody and collateral management module; and a cash and liquidity management module. In an aspect of various embodiments, a platform management module provides input and output functions to the system manager, and the platform management module is configured to support and review negotiation of details of the repo agreement between the collateral provider and the investor and, responsive to a successful negotiation, to execute the repo agreement between the collateral provider and the investor by electronically transferring ownership of the financial instrument from a collateral provider custody account to an investor custody account maintained in said one or more databases in the memory device.

In an aspect of various embodiments, the computer-implemented securities financing system, implemented by, e.g., a custody and collateral management module, maintains both an encumbered account and an unencumbered account in said one or more databases for the benefit of the collateral provider.

In another aspect of this embodiment, a broker/dealer services module may be further configured to initiate a request for a particular security to a third party in response to a determination that the financial instrument is not held within the pool of assets under custody by the system manager.

In another aspect of an embodiment, the computer-implemented securities financing system, implementing a cash and liquidity management module, may be configured such that the financial instrument associated with the repo agreement is maintained under custody and control of the system manager.

In another embodiment, a computer-implemented securities financing system that integrates processing of both securities lending and repurchase (repo) agreement transactions conducted over a network includes a securities financing platform comprising: one or more processors; a memory storage device operatively coupled to the one or more processors, said memory device being configured so as to store processed and unprocessed information related to a financial instrument that is a subject of either the securities lending transaction or repo agreement transaction in one or more databases contained therein; a network communications module; a securities lending services module; a broker/dealer service module; an asset custody/collateral management module; a cash and liquidity management module; and a management interface module through which input and output functions are provided to a system manager. One or more processors may be configured to process information related to the financial instrument, and to transmit the information over the network via the network communications module.

In one or more embodiments, the network communications module may be configured to manage respective data interfaces over the network with at least each of a first party borrower to the collateralized financial transaction, a second party lender to the collateralized financial transaction, and a central counterparty configured to provide trade netting and novation services to each of the first and second parties. The securities lending services module and broker/dealer service module may be configured to match the financial instrument to a security held within a pool of assets under custody by the system manager for one or more clients of the securities financing system who have executed a “give-up agreement” with the system manager.

In one or more embodiments, the management interface may be configured to support and review negotiation of details of the collateralized financial transaction between the first party and the second party and, responsive to a successful negotiation, to execute a trade agreement between the first party borrower and the second party lender for the financial instrument via the broker/dealer service module and the asset custody/collateral module by electronically transferring control between respective lender and borrower custody accounts maintained in said one or more databases in the memory device.

In an aspect of various embodiments, a central counterparty interface between the central counterparty and the securities financing platform over the network may be configured to novate the trade agreement by the central counterparty such that the central counterparty becomes a counterparty to each of the first party borrower and the second party lender through the securities financing system.

In another aspect of this embodiment, the asset custody/collateral management module may be configured to secure, by the system manager and via the management interface module, collateral from the first party borrower for the executed trade agreement. The collateral may be in the form of one or more of cash or securities including stocks, bonds, and/or commercial paper, or a combination of cash and securities being transferred in an electronic form, wherein a transfer includes accounting for a change in custody in one or more databases.

In one or more embodiments, a cash and liquidity management module may be configured such that the financial instrument associated with a repo agreement is maintained under custody and control of the system manager.

In another embodiment, an article of manufacture comprising a tangible computer-readable medium contains computer instructions therein which, when executed by one or more processors, causes the one or more processors to carry out various functionality summarized above with respect to one or more embodiments of a computer-implemented system and method of this disclosure, and as discussed in detail below in the detailed description section.

### BRIEF DISCUSSION OF THE DRAWINGS

FIG. 1 provides a block diagram of an embodiment of a computer-implemented securities financing platform or system shown in one possible networked environment of use;

FIG. 2 illustrates a functional block diagram of an embodiment of a securities financing platform or system based upon securities lending;

FIG. 3 illustrates a functional block diagram of an embodiment of a securities financing platform or system based upon repurchase agreement (“Repo”) financing; and

FIG. 4 illustrates a networked system of an embodiment for securities financing in which a securities financing platform in which either securities lending or repurchase agreement financing may be used.

### DETAILED DESCRIPTION

In the discussion of various embodiments and aspects of the system and method of this disclosure, examples of a processor may include any one or more of, for instance, a personal computer, portable computer, personal digital assistant (PDA), workstation, web-enabled mobile phone, WAP device, web-to-voice device, or other processor-driven device

Those with skill in the art will appreciate that the inventive concept described herein may work with various system configurations. In addition, various embodiments of this disclosure may be made in hardware, firmware, software, or any suitable combination thereof. Aspects of this disclosure may also be implemented as instructions stored on a machine-readable medium, which may be read and executed by one or more processors. A machine-readable medium may include any mechanism for storing or transmitting information in a form readable by a machine (e.g., a computing device, or a signal transmission medium), and may include a machine-readable transmission medium or a machine-readable storage medium. For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions.

The general motivation for Repos is the borrowing or lending of cash, whereas the purpose of securities lending is to temporarily obtain or lend the security for purposes to cover short positions. One or more embodiments of this disclosure provide a financing platform or system that integrates computerized securities lending and Repo financing in one place.

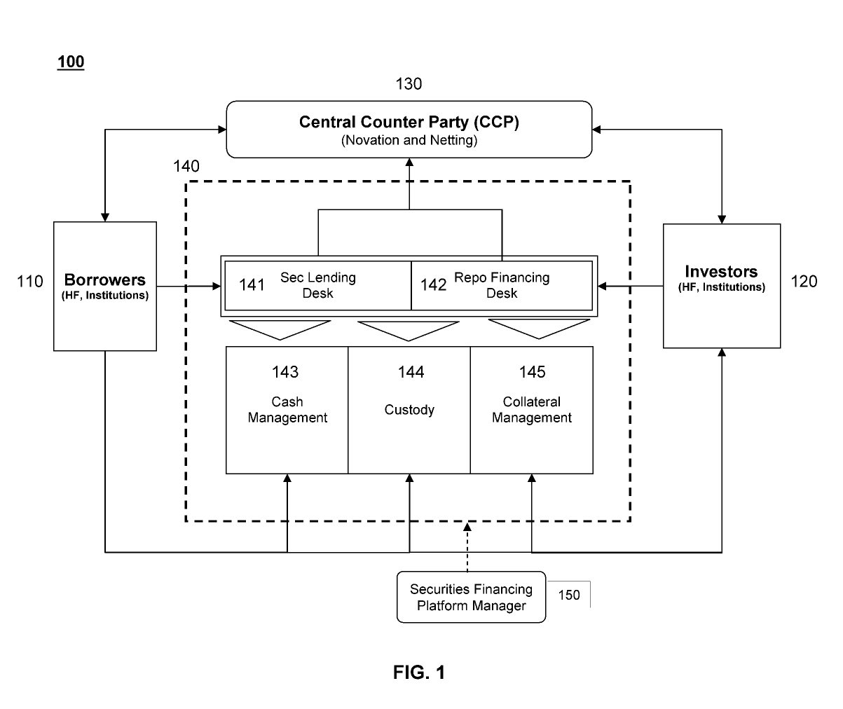

In the embodiment of FIG. 1, a simplified overview of financial trading system 100 includes borrowers 110 (e.g. a hedge fund and/or institutional inventors), investors 120 (e.g. a hedge fund and/or institutional inventors), central counterparty (CCP) 130, and securities financing platform 140 all with appropriate computer interfaces and networked interconnections provided in a known manner to process either Repos, securities lending, or both. A variety of different types of securities may be processed, for example, commercial paper, stocks, Treasury notes, money market funds, etc. A margin or so-called “haircut” may be imposed on non-cash assets to account for market volatility.

A cornerstone of the novel approach in this and other embodiments is in having an electronic interface between securities financing platform 140 and CCP 130, which reduces bilateral credit risk (i.e., counterparty risk) for each party 110, 120 and for platform manager 150 of securities financing platform 140, by configuring CCP 130 to act as the lender to every borrower, and as the borrower to every lender by a novation process. Further, CCP 130 can be used in such a way by securities financing platform 140 to maintain anonymity of one or more parties. In one or more embodiments, the CCP may net the collateral requirements across all transactions conducted on securities financing platform 140. Typically, CCP 130 has or is expected to maintain a better credit rating than conventional broker-dealers that have conventionally been used. Thus, all parties are better protected against risk.

Securities financing platform 140 includes various computer-implemented functional modules or “submodules”. For example, securities lending desk 142 represents an computer interface to systems and data for locating, matching, and executing the trade of securities that are lent to the borrower. Such securities may be located within a pool of assets already held under custody by platform manager 150 of securities financing platform 140 for clients who have previously signed a so-called “give-up” agreement between securities financing platform manager 150 and CCP 130. A “give-up” agreement, among other things, allows an order executed by one entity to be cleared by another entity at the request of the customer. In addition, the term may be used to describe a transaction between three entities, where one does not use their name in order to maintain anonymity.

Repo financing desk 142 represents a computer interface to systems and data for matching orders and executing repo finance trades between borrower(s) 110 and investor(s) 120. Such Repo trades may be located in client custody accounts already maintained by platform manager 150 in securities financing platform 140. Platform manager 150 may sweep required assets from a collateral provider's custody account to segregated collateral account. In a tri-party Repo, platform manager 150, e.g., a custodian bank, controls the movement of securities, and lenders/investors 120 do not actually take delivery of collateralized securities. It should be pointed out that the above actions and functions may be carried out in a “paperless” environment by computerized electronic transactions.

Security lending desk interface 141 and repo financing desk interface 142 rely on integrated functional capabilities of securities financing platform 140. For example, cash management module 143, custody control module 144, and collateral management module 145 operate to support the various required functions to maintain control and accountability of cash, asset custody, and collateral management, and may provide networked interfaces with borrowers 110, investors 120, and platform manager 150.

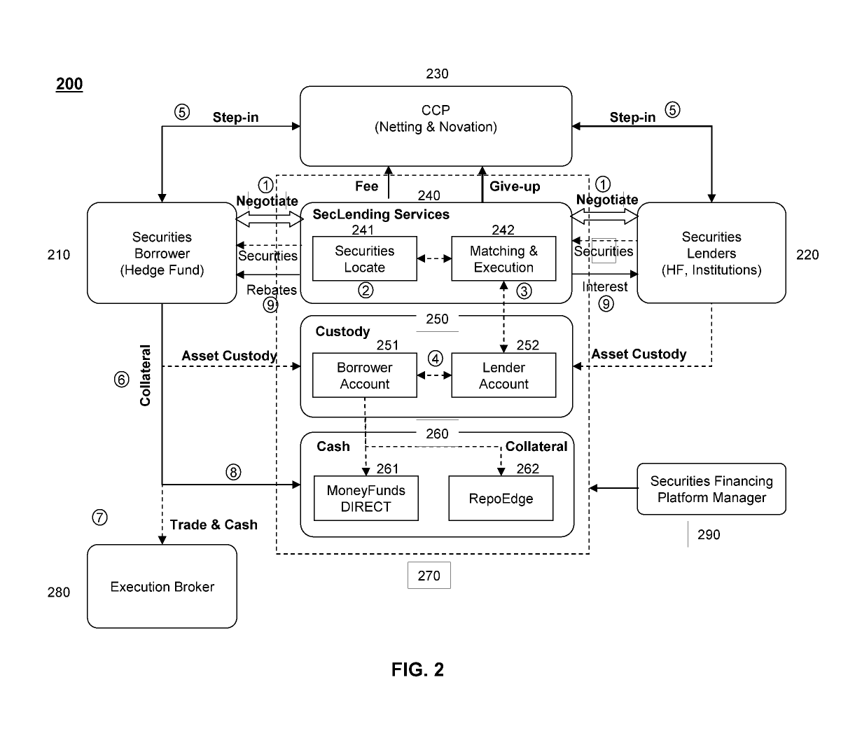

Turning now to FIG. 2, an embodiment of a networked securities financing platform directed to securities lending is provided. The embodiment of FIG. 2 may be considered as being one portion of the platform of FIG. 1, or it may be considered as a stand-alone configuration.

The principal reason for borrowing a security is to cover a short position, as required by matter of law, to engage in short selling. The terms of the loan are governed by a “Securities Lending Agreement” which, under U.S. law, requires that the borrower provides the lender with collateral, in the form of cash, government securities, or a Letter of Credit of value equal to or greater than the loaned securities. A “greater than” value implies underlying volatility of the loaned securities such that a margin or “haircut” is applied to ensure adequate collateralization. At the end of the agreement, borrower 210 will have to return an equivalent security to lender 220. “Equivalent” in this context means fungible, i.e. the securities have to be completely interchangeable. As payment for the loan, the parties 210, 220 negotiate a fee, quoted as an annualized percentage of the value of the loaned securities. If the agreed form of collateral is cash, then the fee may be quoted as a “rebate”, meaning that the lender will earn all of the interest which accrues on the cash collateral, and will “rebate” an agreed rate of interest to the borrower.

In the financial trading system 200 illustrated in FIG. 2, platform manager 290 of securities financing platform or system 270 negotiates terms with securities borrower 210 and securities lender 220 who are willing to lend assets under custody and process the trade on securities financing platform 270, and execute (e.g., by digital signature and/or handwritten confirmation) a one-time master “give up” agreement with platform manager 290 and CCP interface or module 230.

The following numbered discussion is keyed to the circled numerals found in FIG. 2:

1. Hedge fund 210 that needs to borrow securities to execute a trade strategy comes to securities financing platform 270 to borrow needed securities through security lending services module 240 and securities locate submodule 241. Securities borrower 210 opens an account with platform manager 290 if an account is not already established within securities financing platform 270. Platform manager 290 or representatives associated with securities financing platform 270 negotiate lending terms with borrower 210.

2. Securities locate submodule 241 attempts to locate the securities within the pool of assets held under custody for clients who have previously signed a “give up” agreement. If the security is not available internally, platform manager 290 may engage a third party.

3. Assuming that the securities are located internally, matching and execution submodule 242 matches the securities requested with the securities found, and executes trades between borrower 210 and lender 220.

4. Both borrower 210 and lender 220 maintain separate accounts in asset custody management module 250, e.g., borrower account submodule 251 and lender account submodule 252, respectively, and the securities are transferred from lender's account 252 to borrower's account 251.

5. The Central Counter Party, via CCP interface 230 “steps in” and novates the contract, and thus becomes the counterparty to each of borrower 210 and lender 220. By this approach, the anonymity of the parties may be maintained through the life cycle of the transaction.

6. Platform or system management module 290 (which may be operated by a platform manager or agent of the operator/owner of the securities financing platform 220) secures collateral from the borrower via cash/collateral module 260, which typically is in cash (including electronic fund transfers), but which can be in the form of securities such as stocks, bonds, or commercial paper, or a combination of cash and securities. Cash/collateral module 260 is configured to independently provide a safeguard valuation and eligibility test service for non-cash collateral that is allocated to the securities that are lent. If borrower 210 maintains an unencumbered account with platform manager 290, e.g., a money market account accessed through interface 261 such as The Bank of New York's MoneyFunds DIRECT service, a corresponding amount is transferred to encumbered collateral account interface 262, e.g., The Bank of New York's RepoEdge® service. Otherwise, an account for borrower 210 is established. Platform manager 290 invests cash and maintains custody of the securities.

7. Securities borrower 210 executes the trade through broker 280, and covers the short position with the borrowed securities.

8. Platform manager 290 serves as collateral management agent or third party “lockbox” via cash/collateral module 260 to process and account for the cash/collateralizing securities borrowing between entities.

9. Platform manager 290 pays a rebate to borrower 210 and interest on securities borrowed to lender via securities lending services module 240, and also handles recalls, returns and re-rates.

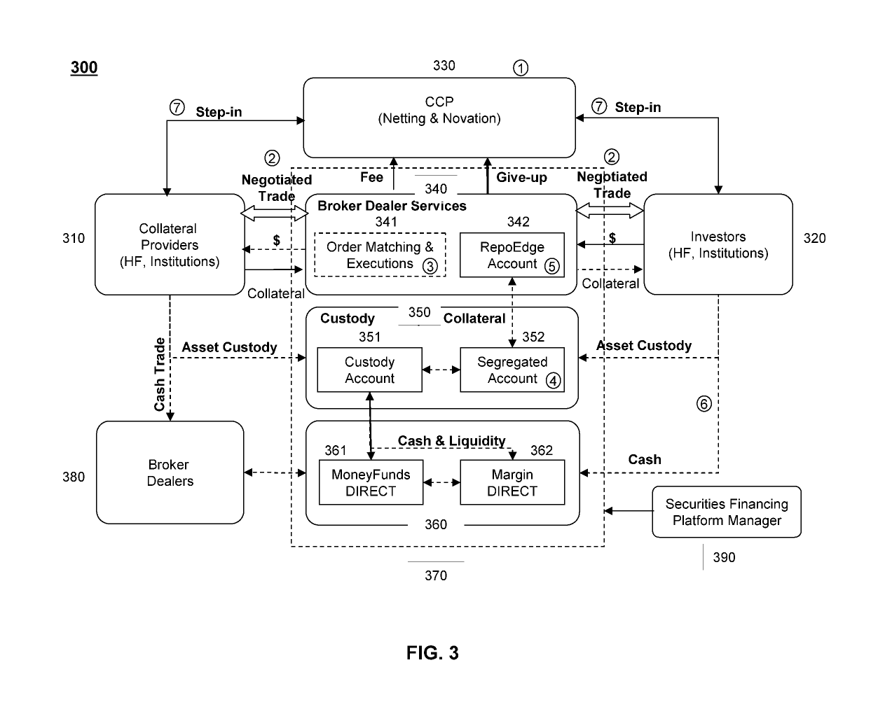

Turning now to FIG. 3, an embodiment of a networked securities financing platform directed to Repo agreements is provided. The embodiment of FIG. 3 may be considered as being one portion of the platform of FIG. 1, or it may be considered as a stand-alone configuration. A sale and repurchase agreement, also known as a “Repo”, is documented with a industry-standard Master Repurchase Agreement. Further discussion of a Repo is provided in the Background section above.

In financial trading system 300 illustrated in FIG. 3, platform manager 390 of securities financing platform or system 370 negotiates trade terms with collateral providers 310, e.g., hedge funds or institutional inventors, and investors 220, e.g., other hedge funds or institutional inventors who are willing to sell assets under custody and process the Repo agreement on securities financing platform 370.

The following numbered discussion is keyed to the circled numerals found in FIG. 3:

1. Collateral provider 310 (e.g., hedge fund), investor 320, securities financing platform manager 390, and CCP 330 negotiate a one time master “give-up” agreement (e.g., ISDA 2005).

2. Collateral provider 310 (e.g., hedge fund) enters into tri-party Repo agreement to borrow cash and utilize leverage. Collateral provider 310 and investor 320 submit order instructions to broker dealer services module 340.

3. Order matching and execution submodule 341 matches orders and executes Repo finance trades with collateral provider 310 and investor 320.

4. Collateral provider 310 and investor 320 each maintain separate custody accounts with platform manager 390 through custody/collateral module interface 350. Custody/collateral module 350 sweeps required assets from collateral provider's custody account 351 to segregated collateral account 352. In a tri-party Repo, the custodian bank, e.g., platform manager 390, controls movement of securities. Lenders do not actually take delivery of collateralized securities.

5. Broker-dealer services module 340 is configured to independently provide a safeguard valuation and eligibility test service for non-cash collateral that is allocated to the Repo agreement. For example, such collateral management may be accomplished by submodule 342 which, for example, could be an account interface with The Bank of New York's RepoEdge® system.

6. Platform manager 390 receives cash from investor 320 to provide to borrower 310 to finance leverage on either an overnight or short-term basis.

7. Platform manager 390 gives up and steps out of the trades, and CCP 330 novates the trades and assumes the role of counterparty to both sides of the transaction. CCP 330 provides intra-day liquidity and credit support by carrying out its netting and novation functions.

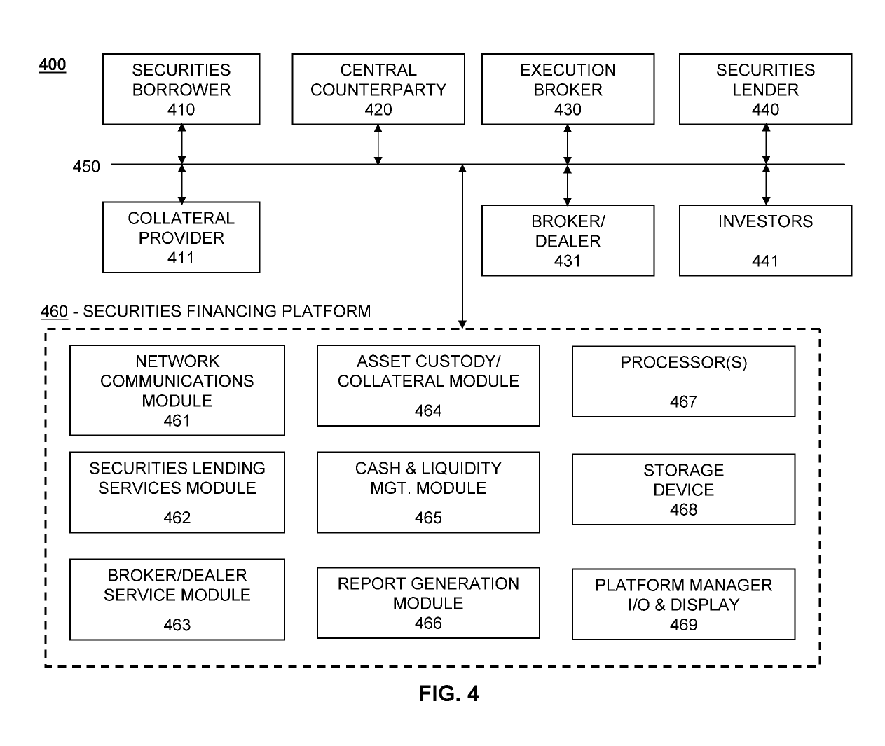

Turning now to FIG. 4, financing system 400 includes novel securities platform 460 of this disclosure. System 400 includes interfaces and/or entities that may be networked together to carry out the functionality and processes discussed above. For example, securities borrower 410, collateral provider 411, central counterparty 420, execution broker 430, broker-dealer 431, securities lender 440, and investors 441 may be electronically connected to securities financing platform 460 via network 450. Network 450 may be the Internet, or may be another type of network, e.g., a private network as is known. Securities borrower 410, central counterparty 420, execution broker 430, and securities lender 440 may be involved with a securities lending transaction through securities financing platform 460 over network 450, while collateral provider 411, central counterparty 420, broker-dealer 431, and investors 441 may be involved with a Repo agreement transaction through securities financing platform 460 over network 450.

Securities financing platform or system 460 may include various modules and/or submodules which carry out the functions and processes discussed herein. For example, securities financing platform 460 may include network communications module 461, which carries out necessary interface actions between securities financing platform 460 and network 450. Securities lending services module 462 may be configured to carry a securities location and matching and execution functions as discussed, for example, with respect to security lending services module 240 in FIG. 2. Broker/dealer service module 463 may be configured to carry out order matching and collateral management functions as discussed, for example, with respect to broker-dealer services module 340 in FIG. 3. Asset custody/collateral module 464 may be configured to carry out custody and collateral management services and functions as discussed, for example, with respect to custody module 250 in FIG. 2 and custody/collateral module 350 in FIG. 3. Cash and liquidity management module 465 may be configured to carry out cash and liquidity management functions associated with, for example, cash and liquidity module 360 in FIG. 3, and/or one or more functions of cash/collateral module 260 in FIG. 2. Report generation module 466 may be configured to produce transaction and/or status reports. Reports, as desired or needed. Each of the above-discussed modules may be implemented by one or more processors “internal” to the respective module, or may be implemented by processor(s) 467, which are programmed by appropriate software to carry out one or more functions associated with securities financing platform 460, and/or the various functions allocated to the various submodules. Storage device 468 may be any type of known memory/storage device, and which is configured to store information relating to the trades and/or sales of securities or Repo agreements, e.g., in a database, including a structured database. Computer program instructions (i.e., “software”) to carry out the various functions associated with securities financing platform 460 may also be stored in storage device 468. Finally, platform manager, input/output (I/O) and display module 469 may be configured to allow the platform manager or a designated user, e.g., a bank employee, to enter, retrieve, and/or display information related to transactions conducted on securities financing platform 460. For example, platform manager I/O and display module 469, may be used by the platform manager when negotiating trades, locating securities, or matching orders, as discussed above with respect to FIGS. 2 and 3.

The above-discussed embodiments and aspects of this disclosure are not intended to be limiting, but have been shown and described for the purposes of illustrating the functional and structural principles of the inventive concept, and are intended to encompass various modifications that would be within the spirit and scope of the following claims.

Various embodiments may be described herein as including a particular feature, structure, or characteristic, but every aspect or embodiment may not necessarily include the particular feature, structure, or characteristic. Further, when a particular feature, structure, or characteristic is described in connection with an embodiment, it will be understood that such feature, structure, or characteristic may be included in connection with other embodiments, whether or not explicitly described. Thus, various changes and modifications may be made to this disclosure without departing from the scope or spirit of the inventive concept described herein. As such, the specification and drawings should be regarded as examples only, and the scope of the inventive concept to be determined solely by the appended claims.

What is claimed is:

1. A computer-implemented method of processing a collateralized financial transaction over a network, the method comprising:
providing a securities financing system including a memory device and one or more processors configured to process information transmitted over the network related to a financial instrument that is connected with the collateralized financial transaction,
said securities financing system including respective network data interfaces with at least each of a first party borrower to the collateralized financial transaction, a second party lender to the collateralized financial transaction, and a central counterparty configured to provide trade netting and novation services to each of the first and second parties, said securities financing system having an interface with a system manager responsible for monitoring and controlling the collateralized financial transaction;
matching the financial instrument through the securities financing system to a security held within a pool of assets under custody by the system manager for one or more clients of the securities financing system, said one or more clients having executed a give-up agreement with the system manager;
negotiating details of the collateralized financial transaction between the first party and the second party through the securities financing system;
responsive to a successful negotiation, executing a trade agreement between the first party borrower and the second party lender for the financial instrument via the network and electronically transferring control of the financial instrument between respective lender and borrower custody accounts maintained in a database in the memory device; and
novating the trade agreement by the central counterparty, wherein the central counterparty becomes a counterparty to each of the first party borrower and the second party lender through the securities financing system.

2. The method of claim 1, further comprising securing, by the system manager, collateral from the first party borrower for the executed trade agreement via a collateral module in the securities financing system, wherein said collateral may be in one or more of cash or securities including stocks, bonds, Letter of Credit, and/or commercial paper, or a combination of cash and securities.

3. The method of claim 2, further comprising independently providing, via said collateral module, a safeguard valuation and eligibility determination for any non-cash collateral that is allocated to the executed trade agreement.

4. The method of claim 1, wherein said securities financing system is configured to integrate processing of both securities lending and Repurchase Agreement financing in a single computer-implemented platform.

5. The method of claim 1, wherein said securities financing system is configured to process securities lending to facilitate covering a short position in a security.

6. The method of claim 1, wherein said securities financing system is configured to process Repurchase Agreement financing to facilitate the borrowing or lending of cash.

7. The method of claim 1, wherein said negotiating details of the collateralized financial transaction is conducted anonymously between the first party and the second party through the securities financing system.

8. A computer-implemented securities financing system for processing a collateralized securities lending transaction over a network, the system comprising:
a securities financing platform comprising:
a network interface configured to provide respective data interfaces over the network with at least each of a securities borrower, a securities lender, and a central counterparty associated with the collateralized securities lending transaction, said central counterparty providing trade netting and novation services for the collateralized securities lending transaction to each of the securities borrower and the securities lender via a central counterparty interface configured to novate a trade agreement by the central counterparty such that the central counterparty becomes a counterparty to each of the securities borrower and the securities lender through the securities financing platform;
one or more processors operatively connected to one or more of a plurality of modules, said one or more processors being configured to process information related to the collateralized securities lending transaction, said information being selectively provided to the network over the network interface;
a memory storage device operatively coupled to the one or more processors, said memory device being configured so as to store information related to a financial instrument that is a subject of the collateralized financial transaction in one or more databases contained therein;
wherein the plurality of modules comprises:
a securities lending services module configured to locate and match the financial instrument to a security held within a pool of assets under custody by a system manager for one or more clients of the securities financing system, said one or more clients having executed a give-up agreement with the system manager;
an asset custody management module; and
a cash and collateral management module; and
a platform management module through which input and output functions are provided to the system manager, said platform management module being configured to support and review negotiation of details of the collateralized financial transaction between the securities borrower and the securities lender and, responsive to a successful negotiation, to execute the trade agreement between the securities borrower and the securities lender by electronically transferring custody of the financial instrument between respective lender and borrower custody accounts maintained in said one or more databases in the memory device.

9. The computer-implemented securities financing system of claim 8, wherein the cash and collateral management module maintains both an encumbered account and an unencumbered account in said one or more databases for the benefit of the securities borrower.

10. The computer-implemented securities financing system of claim 8, wherein the central counterparty interface is configured to provide anonymity between the securities borrower and the securities lender.

11. The computer-implemented securities financing system of claim 8, wherein the securities lending services module is further configured to initiate a request for a particular security to a third party in response to a determination that the financial instrument is not held within the pool of assets under custody by the system manager.

12. The computer-implemented securities financing system of claim 8, wherein said cash and collateral management module is configured to provide, at least to the securities borrower, an independent safeguard valuation and eligibility determination for any non-cash collateral that is allocated to the executed trade agreement.

13. The computer-implemented securities financing system of claim 8, wherein said cash and collateral management module is configured such that any collateral associated with the collateralized securities lending transaction is maintained under custody and control of the system manager.

14. A computer-implemented securities financing system for processing a repurchase (repo) agreement over a network, the system comprising:
a securities financing platform comprising:
a network interface configured to provide respective data interfaces over the network with at least each of a collateral provider, an investor, and a central counterparty associated with the repo agreement, said central counterparty providing trade netting and novation services for the repo agreement to each of the collateral provider and the investor via a central counterparty interface configured to novate a trade agreement by the central counterparty such that the central counterparty becomes a counterparty to each of the collateral provider and the investor through the securities financing platform;
one or more processors operatively connected to one or more of a plurality of modules, said one or more processors being configured to process information related to the repo agreement, said information being selectively provided to the network over the network interface;
a memory storage device operatively coupled to the one or more processors, said memory device being configured so as to store information related to a financial instrument that is a subject of the repo agreement in one or more databases contained therein;
wherein the plurality of modules comprises:
a broker/dealer services module configured to locate and match the financial instrument to a security held within a pool of assets under custody by a system manager for one or more clients of the securities financing system, said one or more clients having executed a give-up agreement with the system manager;
a custody and collateral management module; and
a cash and liquidity management module; and
a platform management module through which input and output functions are provided to the system manager, said platform management module being configured to support and review negotiation of details of the repo agreement between the collateral provider and the investor and, responsive to a successful negotiation, to execute the repo agreement between the collateral provider and the investor by electronically transferring ownership of the financial instrument from a collateral provider custody account to an investor custody account maintained in said one or more databases in the memory device.

15. The computer-implemented securities financing system of claim 14, wherein the custody and collateral management module maintains both an encumbered account and an unencumbered account in said one or more databases for the benefit of the collateral provider.

16. The computer-implemented securities financing system of claim 14, wherein the central counterparty interface is configured to provide anonymity between the investor and the collateral provider.

17. The computer-implemented securities financing system of claim 14, wherein the broker/dealer services module is further configured to initiate a request for a particular security to a third party in response to a determination that the financial instrument is not held within the pool of assets under custody by the system manager.

18. The computer-implemented securities financing system of claim 14, wherein said cash and liquidity management module is configured to provide, at least to the investor, an independent safeguard valuation and eligibility determination for any collateral that is allocated to the repo agreement.

19. The computer-implemented securities financing system of claim 14, wherein said cash and liquidity management module is configured such that the financial instrument associated with the repo agreement is maintained under custody and control of the system manager.

20. A computer-implemented securities financing system that integrates processing of both securities lending and repurchase (repo) agreement transactions conducted over a network, the system comprising:
a securities financing platform comprising:
one or more processors;
a memory storage device operatively coupled to the one or more processors, said memory device being configured so as to store processed and unprocessed information related to a financial instrument that is a subject of either the securities lending transaction or repo agreement transaction in one or more databases contained therein;
a network communications module;
a securities lending services module;
a broker/dealer service module;
an asset custody/collateral management module;
a cash and liquidity management module; and
a management interface module through which input and output functions are provided to a system manager;
wherein said one or more processors are configured to process information related to the financial instrument, said information being transmitted over the network via the network communications module,
wherein said network communications module is configured to manage respective data interfaces over the network with at least each of a first party borrower to the collateralized financial transaction, a second party lender to the collateralized financial transaction, and a central counterparty configured to provide trade netting and novation services to each of the first and second parties,
wherein said securities lending services module and said broker/dealer service module are configured to match the financial instrument to a security held within a pool of assets under custody by the system manager for one or more clients of the securities financing system, said one or more clients having executed a give-up agreement with the system manager,
wherein the management interface is configured to support and review negotiation of details of the collateralized financial transaction between the first party and the second party and, responsive to a successful negotiation, to execute a trade agreement between the first party borrower and the second party lender for the financial instrument via the broker/dealer service module and the asset custody/collateral module by electronically transferring control between respective lender and borrower custody accounts maintained in said one or more databases in the memory device; and
a central counterparty interface between the central counterparty and the securities financing platform and via the network, said central counterparty interface configured to novate the trade agreement by the central counterparty such that the central counterparty becomes a counterparty to each of the first party borrower and the second party lender through the securities financing system.

21. The system of claim 20, wherein said asset custody/collateral management module is configured to secure, by the system manager and via the management interface module, collateral from the first party borrower for the executed trade agreement, wherein said collateral may be in one or more of cash or securities including stocks, bonds, and/or commercial paper, or a combination of cash and securities being transferred in an electronic form, wherein said transfer at least comprises accounting for a change in custody in said one or more databases.

22. The system of claim 20, wherein said securities lending services module independently provides a safeguard valuation and eligibility testing for any non-cash collateral that is allocated to the executed trade agreement for a financial security lending transaction that covers a short sale transaction.

23. The system of claim 20, wherein said cash and liquidity management module is configured such that the financial instrument associated with a repo agreement is maintained under custody and control of the system manager.

24. The system of claim 20, wherein the central counterparty interface is configured to provide anonymity between a first party and a second party to either the securities lending transaction or repo agreement transaction.

25. An article of manufacture comprising a tangible computer-readable medium containing computer instructions therein which, when executed by one or more processors, causes said one or more processors to carry out the method of claim 1.
